(19) United States
(12) Patent Application Publication
(10) Pub. No.: US 2004/0234047 A1
(43) Pub. Date: Nov. 25, 2004

(54) Interactive telephony interface

(75) Inventors: Lawrence Ciccarelli, East Setauket, NY (US); Jacob Levine, Port Jefferson Station, NY (US)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/444,339

(22) Filed: May 23, 2003

(51) Int. Cl. H04M 1/64

(52) U.S. Cl. 379/88.16; 379/88.01

(57) ABSTRACT

The present invention provides an interactive telephony interface for a user via a telephony terminal. Upon initiating an interaction with the telephony terminal, a session is provided between the telephony terminal and an interactive control system (ICS), which is capable of responding to commands for requested services from the user and initiating those services. The services can range from initiating a telephone call from the telephony terminal to requesting retrieval of information or triggering any number of actions. The provision of such services may be initiated by accessing service logic from within the ICS or within remote servers accessible by the ICS. The user may request multiple services at any given time, and the ICS will respond by initiating the services during a single telephony interaction. The ICS is also capable of providing unsolicited information, such as advertisements, to the user while waiting for the requested services to be provided.

### FIELD OF THE INVENTION

The present invention relates to telephony communications, and in particular to providing an interactive telephony interface capable of simultaneously facilitating multiple services for a given user.

### BACKGROUND OF THE INVENTION

The traditional telephony interface revolves around various types of tones, pulses, and like audible signals. For example, a dial tone indicates a readiness to receive a directory number to initiate a call, a ring back signal indicates the called party's telephone is ringing, and a busy signal indicates the called party's line is busy. During any telephony interaction, a user is significantly limited as to the number and sequence of options available. For example, when a user picks up a telephone and a dial tone is presented, the user only has the options of placing a call or hanging up. Similarly, when a user is waiting for a called party to answer, no other options are available except to hang up and end the call.

Generally, only one telephony service is available at any given time. Even when multiple services are theoretically available, the antiquated interface limits user interaction, and specifically limits the number of options that can be offered to a user. There are numerous points during which a telephony service is accessed in which the user is simply waiting and listening to a ringing signal, a dial tone, or the like. Accordingly, there is a need for a way in which to offer multiple telephony services during a single telephone interaction. There is a further need to take advantage of the time during which a user is waiting for services to be provided or calls to be completed, in place of traditional progress tones, pulses, or silence.

### SUMMARY OF THE INVENTION

The present invention provides an interactive telephony interface for a user via a telephony terminal. Upon initiating an interaction with the telephony terminal, a session is provided between the telephony terminal and an interactive control system (ICS), which is capable of responding to commands for requested services from the user and initiating those services. The services can range from initiating a telephone call from the telephony terminal to requesting retrieval of information or triggering any number of actions. The provision of such services may be initiated by accessing service logic from within the ICS or within remote servers accessible by the ICS. Notably, the user may request multiple services at any given time, and the ICS will respond by initiating the services during a single telephony interaction. A single telephony interaction is one in which a user initiates interaction and requests one or more services prior to ending the interaction. The ICS is also capable of providing unsolicited information, such as advertisements, to the user as the user waits for the requested services to be provided.

The ICS may interface with any number of telephony networks, such as the Public Switched Telephone Network (PSTN), cellular networks, or packet-switched networks to facilitate the interactive telephony interface. Preferably, the interface is voice-based, wherein spoken commands are recognized by associated speech recognition functions provided by the ICS. The ICS will also include text-to-speech functionality for providing voice-based information to the user as necessary. The invention is particularly beneficial for allowing users to initiate telephone calls in addition to other services, wherein the telephone call is attempted while the other services are being accessed or otherwise provided to the user. Further, advertisements may be provided to the user during these periods in which the requested services are being initiated.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIGS. 2A and 2B provide a flow diagram outlining the basic operation of the present invention according to one embodiment.

FIGS. 3A and 3B provide a communication flow diagram outlining a communication flow for an exemplary embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention provides a highly interactive telephony interface capable of facilitating multiple telephony services during a single user interaction. When a user initiates interaction with a telephony terminal, multiple services are available, and one or more of these services may be selected and provided at the same time or sequentially, as time permits. In one embodiment, initiating interaction with a telephony terminal triggers a voice interaction wherein a user can speak commands to select one or more services, which include initiating a call, requesting information, or initiating a task. Further, unsolicited information may be provided to the user during use of the telephony terminal. Preferably, many of the traditional audible tones and signals are replaced with voice commands and audible responses, and multiple services are available at virtually any time, instead of being limited to essentially one service during any given situation. In essence, the traditional telephony interface is replaced with a service-based command center. The present invention provides a telephony interface, which is capable of providing multiple services during a single interaction.

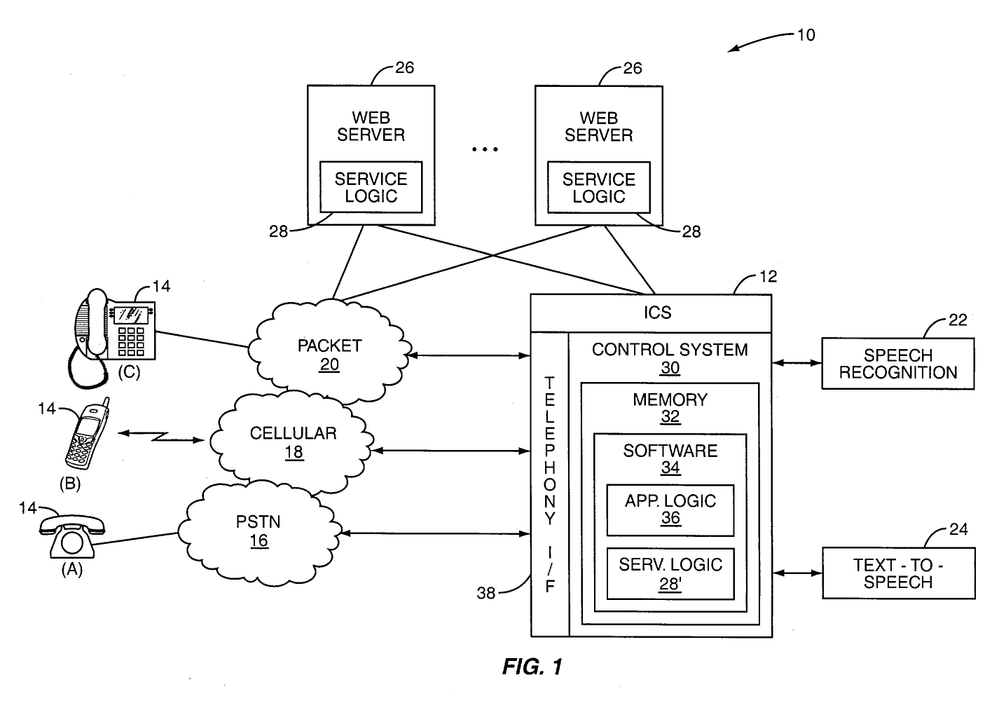

Turning now to FIG. 1, an exemplary communication environment 10 is provided wherein an interactive control system (ICS) 12 functions as a central control center for telephony interactions with users of virtually any type of telephony terminal 14, such as Public Switched Telephone Network (PSTN) telephones 14A, mobile terminals 14B, such as mobile telephones, personal digital assistants, and the like, as well as packet-based terminals 14C. Accordingly, the ICS 12 may be configured to interact with one or more telephony networks, such as the PSTN 16, cellular networks 18, and packet networks 20, such as the Internet or appropriate local or wide area networks. In operation, when a user initiates interaction with one of the telephony terminals 14, the PSTN 16, cellular network 18, or packet network 20 will facilitate a voice session with the ICS 12 immediately, and preferably without using traditional dial tones or ringing signals. Instead, the ICS 12 will recognize the connection and await a user command, which will trigger the ICS 12 to initiate a corresponding service for the user. In one embodiment, an announcement or greeting is provided by the ICS 12 when the connection is realized.

Although the interaction can use tones, such as Dual Tone Multi-Frequency (DTMF) tones and key-based signaling, a voice-based interface provides greater flexibility and convenience for the user. Accordingly, the ICS 12 will either include or be associated with a speech recognition function 22 and a text-to-speech function 24. The speech recognition function 22 operates to recognize commands and other information spoken by the user and convert them to electronic information capable of being understood and processed by the ICS 12. Accordingly, the speech recognition function 22 allows the ICS 12 to understand spoken commands from the user and respond in a desired fashion. In contrast, the text-to-speech function 24 will operate to convert data to be delivered to the user into an audible, voice-based format that is easily understood by the user. The text-to-speech function 24 is generally implemented in association with electronics providing analog-to-digital conversion of the speech signal and a signal processing module that processes the digitized samples of the speech signal and converts them to a series of patterns, which are then compared to a set of stored models that have been constructed based on a knowledge of acoustics, language, and dictionaries. Thus, with the speech recognition function 22 and the text-to-speech function 24, a bi-directional voice interaction with the user is facilitated.

To provide or at least initiate telephony services for the user, the ICS 12 may access or otherwise instruct web servers 26, which include service logic 28, to assist in providing the telephony services requested by the user. The web servers 26 may function to provide telephony services directly or indirectly to the user or provide information for services back to the ICS 12. In general, the ICS 12 can interact with the web servers 26 to receive information to be sent to the user through the ICS 12, instruct the web server 26 to send information to the telephony terminals 14 outside of the ICS 12, or instruct the web servers 26 to take some other action to effect the service selected by the user. The service logic 28 is configured as necessary to provide the desired functionality specified by the telephony services. The ICS 12 may also provide service logic 28′, such that external web servers 26 or like devices do not need to be accessed to facilitate select services desired by the user. The web server 26 may be administered by an independent service provider. The ICS 12 may provide access for the user to utilize these services.

The ICS 12 includes a control system 30 having sufficient memory 32 for the software application 34 necessary for operating the ICS 12. The software application 34 has application logic 36, which controls the basic functionality (access to and switching between the various services) of the ICS 12, and the service logic 28′, which may be used to provide services requested by the user. In addition to operatively interacting with the speech recognition function 22 and the text-to-speech function 24, the control system 30 is also associated with a telephony interface 38, which is capable of interacting with one or more of the PSTN 16, cellular network 18, and packet network 20.

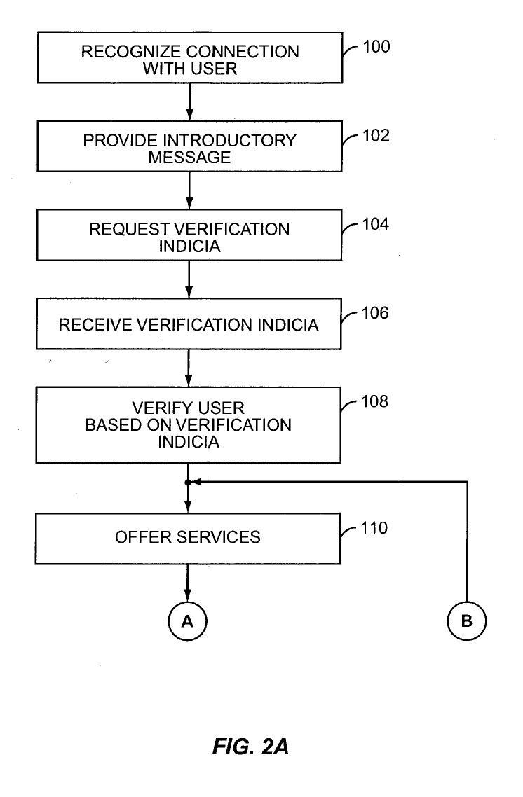

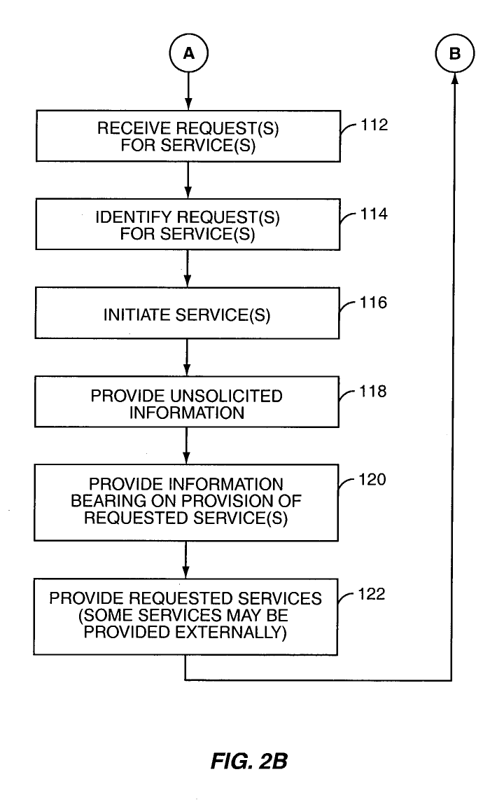

Turning now to FIGS. 2A and 2B, a flow diagram outlines the basic operation of the present invention from the perspective of the ICS 12, according to one embodiment. When a user initiates use of a telephony terminal 14, the respective PSTN 16, cellular network 18, or packet network 20 will establish a connection or appropriate session providing bi-directional communications between the telephony terminal 14 and the ICS 12.

Upon recognizing that the user is initiating a telephony interaction, the ICS 12 will recognize the connection with the user (step 100) and preferably provide an introductory message to alert the user that the ICS 12 is available (step 102). Depending on the level of individual services, the user's identity may need to be verified, and as such, the ICS 12 may request verification indicia from the user (step 104) and then receive the requested verification indicia (step 106). Depending on the configuration of the ICS 12, the response may be through text or tones entered at the telephony terminal 14, but can be provided through a vocal response capable of being recognized by the speech recognition function 22. Upon receiving the verification indicia, the ICS 12 will verify the user's identity based on the verification indicia (step 108). At this point, the user is verified and the ICS 12 is ready to provide services for the user based on the user's commands. Upon verification, the ICS 12 may provide another announcement offering to the identified user available services that may be tailored for each user (step 110), wherein the offering of services may also provide information telling the user what commands are available to select the various services. For example, the announcement may tell the user to speak different commands or touch various buttons on the telephony terminal 14 to select a service. The ICS 12 will receive one or more requests in sequence or in parallel for one or more services (step 112). Once the ICS 12 identifies the request(s) for service(s) (step 114), the service(s) is initiated by instructing the web servers 26 to provide information, take certain actions, and the like to fulfill the requested service(s) (step 116). For example, the requested services may be initiating a telephone call to a certain directory number, sending an instant message, sending an email, receiving requested information, scheduling an appointment, adding a contact to a contact list, and the like. Further, any of the services can be provided virtually simultaneously and can be managed as desired by the service provider, the user, or a combination thereof, depending on the configuration of the ICS 12.

Importantly, while the requested services are being initiated, the ICS 12 can, alone or in association with one or more of the web servers 26, provide or otherwise push unsolicited information to the user, such as advertisements, instructions on how to use the system, or any type of information deemed appropriate using geographic, demographic, or other criteria (step 118). For example, if the user requested a call to be initiated to a certain directory number, while the call is being established and connected, the ICS 12 could access an advertisement and provide it to the user during the connect time. Further, the advertisement could be general, where all users get the same advertisement, may be user-specific, which may be based on preferences provided by the user during initial provisioning, or may be based on information about the user gathered by the service provider. Thus, general or targeted advertising can be provided during the times in which services are being initiated or established.

If specific information was requested or information must be sent to a user based on the requested service, the ICS 12 will work with the text-to-speech function 24 to provide the information bearing on the provision of the requested services to the user (step 120). Next, any of the requested services may be provided by the ICS 12 directly or indirectly via the appropriate web servers 26 or like devices (step 122). If the user requested the ICS 12 to establish a telephone call, the web server 26 may be configured to cooperate with the PSTN 16 to effectively connect a user to the desired called party. Upon interacting with their telephony terminals 14, the users have a virtual assistant provided to them by the ICS 12, wherein the virtual assistant is capable of responding to spoken commands and is capable of initiating or otherwise providing multiple services in one telephony interaction.

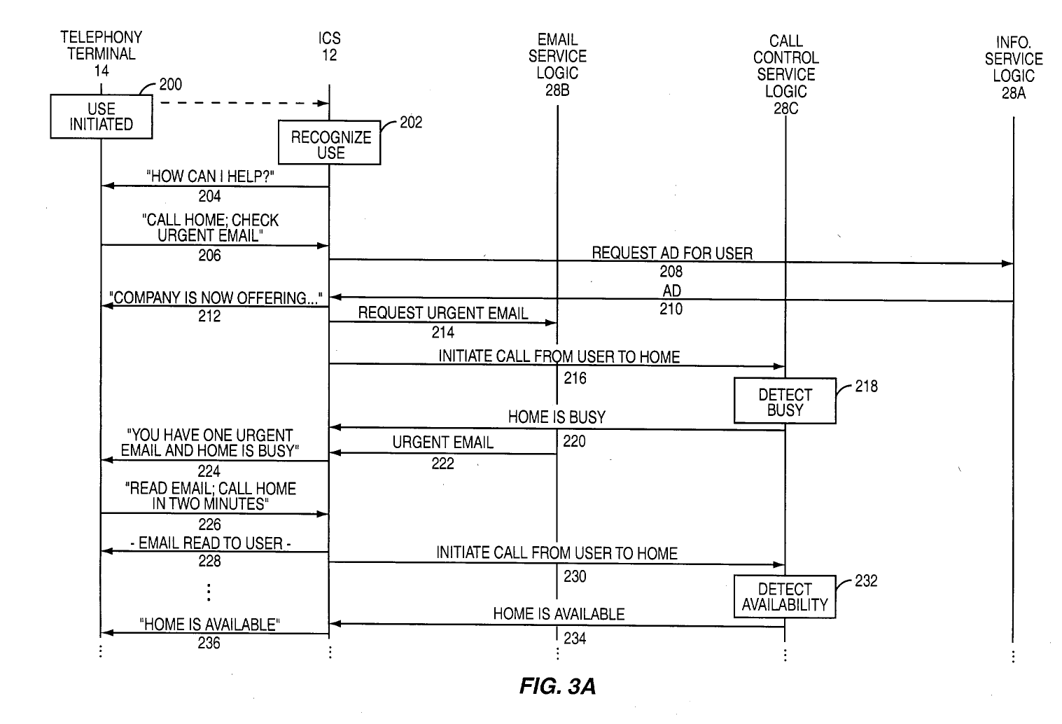

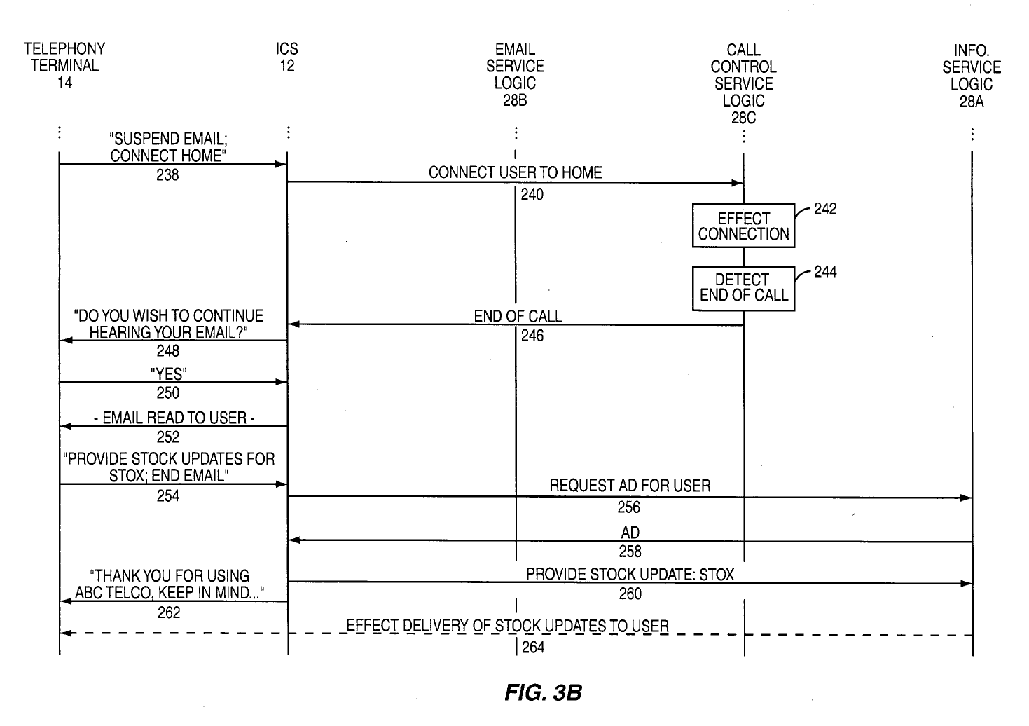

A scenario is provided in the communication flow diagram of FIGS. 3A and 3B. Initially, use is initiated at the telephony terminal 14 by the user (step 200). The ICS 12 is connected to the user terminal 14 by the appropriate network, and will recognize the initiation of use by the user (step 202). The ICS 12 may be configured to provide an initial announcement of, “How can I help?” (step 204), which is heard by the user. The user desires to call home, as well as check email that is designated as urgent, using an email reader service, which will effectively check her email and read any urgent email to her over the voice session. According to a predefined rule set, which defines how the ICS 12 will respond to user commands, the user will speak the command, “Call home,” followed by, “Check urgent email,” (step 206). The ICS 12 will use the speech recognition function 22 to recognize these spoken commands, and will begin processing the request. During the processing, the ICS 12 will request an advertisement for the user, which may be general or targeted, from an information service logic 28A, which may be provided in the web servers 26 or the ICS 12 (step 208). The information service logic 28A will respond with an appropriate advertisement (step 210). The ICS 12 will use the text-to-speech function 24 to effectively read the advertisement to the user via the established voice session (step 212).

The ICS 12 will send a request to access the urgent email of the user to email service logic 28B, which is capable of accessing the user's email and determining whether or not the accessible email is urgent (step 214). The ICS 12 then sends a message to call control service logic 28C to initiate a call from the user to the called number, which is the user's home telephone number (step 216). The call control service logic 28C is capable of interacting with one of the telephony networks 16, 18, 20 to effectively initiate or route the call to the user's home. Assume that the home telephone number is busy and the call control service logic 28C is capable of detecting the state of the home telephone line through interaction with the appropriate network (step 218). The call control service logic 28C will send a message to the ICS 12 indicating the home telephone line is busy (step 220). Meanwhile, the email service logic 28B will download or otherwise retrieve the urgent email to the ICS 12 (step 222).

The ICS 12 will at this point determine that the home telephone line is busy, and that urgent email is available. As such, the ICS 12 can formulate a message to the user, such as, “You have one urgent email and home is busy,” and send this voice-based message to the user via the telephony terminal 14 (step 224). The ICS 12 will then wait for a reply from the user. Again, based on a defined command set, the user can speak, “Read email; call home in two minutes,” (step 226) to trigger the ICS 12 to begin reading the urgent email or cooperating with the email service logic 28B to have it read the email to the user via the session established between the telephony terminal 14 and the ICS 12 (step 228).

After the two minute period, the ICS 12 will again initiate a call from the user to the user's home by sending a like message to the call control service logic 28C (step 230). The call control service logic 28C will monitor the state of the home telephone line (or home telephone or home telephone number), and assuming the home telephone line is now available, detect the home telephone's availability (step 232), and send a message indicating that the home telephone line is available back to the ICS 12 (step 234). The ICS 12 will formulate a message, suspend the reading of the email, and inject a voice message indicating that the home telephone line is available to the telephony terminal 14 (step 236). The user can then respond by speaking an appropriate command, such as, “Suspend email; connect home,” (step 238), which will trigger the ICS 12 to suspend the email reading application and facilitate a connection to the home telephone. Thus, the ICS 12 will send a message to connect the user to the home telephone line to the call control service logic 28C (step 240), which will effect the connection (step 242), wherein the user will be connected via a connection to the home telephone number through circuit-switched or packet-based formats.

The call control service logic 28C may be configured to detect the end the call (step 244), and send a message indicating the call has ended to the ICS 12 (step 246). This may create and provide a message responsive to the last user command, such as, “Do you wish to continue hearing your email?” (step 248). The user can respond with a “Yes” command (step 250), which will trigger the ICS 12 to continue the email reading application (step 252). The user may initiate a service to receive financial information, weather information, directions to a particular location, or the like. For example, the user may initiate a service to receive stock updates for a company named STOX, and end the email reading service. Thus, the user may speak a command, “Provide stock updates for STOX; end email,” (step 254). The ICS 12 will take the necessary steps to respond to these requests, and can again request an advertisement for the user from the information service logic 28A (step 256), which will respond with a generic or targeted advertisement for the user (step 258). The ICS 12 can also send a message to the information service logic 28A to provide a stock update or periodic updates for the company STOX to the user (step 260). The ICS 12 will in the meantime stop reading email to the user, and preferably provide an end of session announcement, along with the requested advertisement for the user (step 262).

With respect to the requested stock updates, a first update could be provided with the end announcement, or prior to the end announcement. Alternatively, the information service logic 28A may be configured to effect delivery of the stock updates to the user in a variety of ways, including after the session between the telephony terminal 14 and the ICS 12 has ended. Thus, the information service logic 28A may be configured to send the stock updates to the telephony terminal 14 using a text messaging service, by initiating a call back to the telephony terminal 14, sending the stock updates through email or instant messaging to a computing device associated with the telephony terminal 14, using a short messaging service to send messages to a mobile telephony terminal 14B, and the like (step 264). Those skilled in the art will recognize numerous ways in which the ICS 12 can initiate a subsequent service based on commands received during the interactive session (call) with the user.

With the present invention, virtually any existing communication service and future services can be made available to a user through an easy-to-use and efficient interface during a single interaction, or session, without having to initiate a new interaction for each service. The interface is generally referred to as a connectionless interface, because multiple services can be requested and provided at the same time. Based on the above teachings, those skilled in the art will recognize numerous applicable services where a user can provide instructions to initiate actions, receive information at the telephony terminal 14 or other associated device, send information to a third party, or subscribe to updates for information for herself or for others, in addition to simply making calls, requesting directory assistance, and the like. These services are most beneficial wherein dial tones and telephony signals are substantially bypassed and interaction with a telephony terminal results in an automatic session with the ICS 12, which can then provide the necessary interaction with the user to fulfill the services requested by the user, alone or in combination with remote web servers 26 and the like. Further, unsolicited information can be provided to the user during lulls, during which time is normally wasted waiting for a service to be provided, such as when a user is waiting for a call to be connected.

Those skilled in the art will recognize improvements and modifications to the preferred embodiments of the present invention. All such improvements and modifications are considered within the scope of the concepts disclosed herein and the claims that follow.

What is claimed is:

1. A method for providing an interactive telephony interface for a user upon establishing a session with a telephony device of a user when the user initiates interaction with the telephony device comprising:
a) receiving a plurality of commands from the user, the commands identifying desired services; and
b) initiating provision of the desired services,
wherein an interactive telephony interface supporting a plurality of services is provided to the user upon initiating use of the telephony device.

2. The method of claim 1 further comprising:
a) accessing information for a desired service on behalf of the user; and
b) delivering the information to the user via the session.

3. The method of claim 2 wherein the plurality of commands are spoken by the user and further comprising interpreting the spoken commands to determine the desired services and providing the information to the user in spoken form.

4. The method of claim 1 further comprising providing unsolicited information to the user via the session.

5. The method of claim 1 further comprising providing a greeting inviting the user to provide the plurality of commands.

6. The method of claim 1 wherein the session is established without providing a dial tone.

7. The method of claim 1 wherein one of the desired services is to originate a call to a called party wherein the call is established between the telephony terminal and the called party.

8. The method of claim 7 wherein a second of the desired services is provided when an attempt to establish the call is being made.

9. The method of claim 7 further comprising providing an advertisement to the user when an attempt to establish the call is being made.

10. The method of claim 1 wherein one of the desired services is to provide an action on behalf of the user.

11. The method of claim 1 further comprising receiving additional commands after initiating the desired services and initiating additional services corresponding to and upon receipt of the additional commands.

12. An interactive control system for providing an interactive telephony interface for a user upon establishing a session with a telephony device of a user via the telephony network when the user initiates interaction with the telephony device comprising:
a) a telephony interface adapted to facilitate communication with a telephony terminal via a telephony network;
b) a control system associated with the telephony interface and adapted to:
i) receive a plurality of commands from the user, the commands identifying desired services; and
ii) concurrently initiate provision of the desired services,
wherein an interactive telephony interface supporting a plurality of services is provided to the user upon initiating use of the telephony device.

13. The interactive control system of claim 12 wherein the control system is further adapted to:
a) access information for a desired service on behalf of the user; and
b) deliver the information to the user via the session.

14. The interactive control system of claim 13 wherein the plurality of commands are spoken by the user and wherein the control system is further adapted to interpret the spoken commands to determine the desired services and provide the information to the user in spoken form.

15. The interactive control system of claim 12 wherein the control system is further adapted to provide unsolicited information to the user via the session.

16. The interactive control system of claim 12 wherein the control system is further adapted to provide a greeting inviting the user to provide the plurality of commands.

17. The interactive control system of claim 12 wherein the session is established without providing a dial tone.

18. The interactive control system of claim 12 wherein one of the desired services is to originate a call to a called party wherein the call is established between the telephony terminal and the called party.

19. The interactive control system of claim 18 wherein a second of the desired services is provided when an attempt to establish the call is being made.

20. The interactive control system of claim 18 wherein the control system is further adapted to provide an advertisement to the user when an attempt to establish the call is being made.

21. The interactive control system of claim 12 wherein one of the desired services is to provide an action on behalf of the user.

22. The interactive control system of claim 12 wherein the control system is further adapted to receive additional commands after initiating the desired services and initiate additional services corresponding to and upon receipt of the additional commands.

23. A computer readable medium comprising software for providing an interactive telephony interface for a user upon establishing a session with a telephony device of a user when the user initiates interaction with the telephony device, the software comprising instructions for a control system to:
a) receive a plurality of commands from the user, the commands identifying desired services; and
b) concurrently initiate provision of the desired services,
wherein an interactive telephony interface supporting a plurality of services is provided to the user upon initiating use of the telephony device.
